(19) United States
(12) Patent Application Publication
(10) Pub. No.: US 2010/0252669 A1
(43) Pub. Date: Oct. 7, 2010

(54) Food cutting device

(76) Inventor: John J. Romano, Conshohocken, PA (US)

Correspondence Address: Jerome E. Sacks, P.O. Box 601, Lexington, MA, 02420, US

(21) Appl. No.: 12/661,910

(22) Filed: Mar. 26, 2010

Related U.S. Application Data
(60) Provisional application No. 61/211,615, filed on Apr. 1, 2009.

(51) Int. Cl. B02C 19/20

(52) U.S. Cl. 241/273.2

(57) ABSTRACT

A hand-held device for cutting food using a circular cutting motion is disclosed. The devise is comprised of a circular disk attached to an annular ring that is designed to be held by a user. The circular disk has one or more cutting edges oriented to cut food that is pressed against the circular disk and moved in a rotational direction. In one embodiment, a plurality of grating elements are used to grate food pieces such as cheese. In an alternate embodiment, cutting elements that cut slices and julienne strips are employed. An optional embodiment employs mechanisms that adjust the height of the cutting elements that cut slices and julienne strips. An optional food holding assembly may be incorporated in the device.

### CROSS-REFERENCE TO RELATED APPLICATIONS

This application claims the benefit of the U.S. Provisional Patent Application No. 61/211,615 filed Apr. 1, 2009 by the present inventor. This provisional patent application is incorporated herein by reference.

### TECHNICAL FIELD

This invention relates to food cutting devices such as food graters and mandolins. More particularly, it relates to food cutting devices that are hand held and operate without motors.

### BACKGROUND OF THE DISCLOSURE

There exist many graters that are designed to grate food pieces into small particles. The food graters generally fall into two categories: those wherein the food piece to be grated is moved rotationally about a grating surface, and those that engage a food piece that is moved in a back and forth direction across a grating surface. The graters that move the food piece in a rotational direction are typically either power driven or are part of a machine that a user operates. The second category typically involves a device that the user operates manually such as a box grater or a panel grater. The graters falling into the first category are more efficient than those of the second category since they continually grate the food piece while the food piece is in motion against the grater's cutting edges. The grating devices in the second category either grate the food piece during only one half the strokes, or have the cutting edges of the grater aligned suboptimally with the cutting direction.

Similarly, food slicers such as tomato slicers and julienne slicers that cut food into shapes like French fry strips typically are mandolin type devices that require an up and down cutting motion. The comparison of food grater categories apply to food slicers also by analogy.

### SUMMARY OF THE DISCLOSURE

The food cutting device presented herein is a device that preserves the more efficient rotational motion of the food piece pressed against a grater surface with one hand while holding the device with the other hand. In several embodiments presented herein, grating disk cutting edges are each aligned in a rotational direction that is opposed to the circular motion of the food piece while being pressed against the grating disk by a user. In other embodiments, slicing disks are used to cut slices or julienne strips. Mechanisms for adjusting the height of the slicing mechanisms are also presented. A food holding device that holds food pieces is included that works with both food graters and food slicers.

What is novel about this food cutting device is that it incorporates the more effective circular motion of a food piece engaging the cutting disk's cutting edges into a manual device that is easily held by a user, inexpensive to manufacture and simple to clean. The cutting edges of the cutting disk are each positioned on the disk surface optimally positioned to engage the food piece when the food piece itself is rotated in a circular direction while being pressed against the disk.

### BRIEF DESCRIPTION OF THE DRAWINGS

FIG. 1 illustrates a perspective view of the first embodiment of the present invention.

FIG. 2 illustrates a perspective view of a grating element of the first embodiment of the present invention.

FIG. 3 illustrates a front sectional view of the first embodiment of the present invention.

FIG. 4 illustrates a detail sectional view of a portion of FIG. 3.

FIG. 5 illustrates the first embodiment of the present invention dimensioned such that it fits over a container.

FIG. 6 illustrates a perspective view of a second embodiment of the present invention.

FIG. 7 illustrates an exploded view of the second embodiment of the present invention.

FIG. 8 illustrates a perspective view of a third embodiment of the present invention.

FIG. 9 illustrates an exploded view of the third embodiment of the present invention.

FIG. 9A illustrates a sectional view of the grating disk ready to be attached to the annular collar of the third embodiment of the present invention.

FIG. 9B illustrates a sectional view of the grating disk attached to the annular collar of the third embodiment of the present invention.

FIGS. 10 and 10A illustrate a detail perspective view and a sectional view of an alternate embodiment to the third embodiment of the present invention.

FIG. 11 illustrates a fourth embodiment of the present invention.

FIG. 12 illustrates an upper front perspective view of a fifth embodiment of the present invention.

FIGS. 13A and 13B illustrates a front exploded view of the two assemblies comprising the fifth embodiment of the present invention.

FIG. 13C illustrates a front perspective view of a lower slotted washer viewed from below of the fifth embodiment of the present invention.

FIG. 13D illustrates a front perspective view of a cradle stop of the fifth embodiment of the present invention.

FIG. 14 illustrates an exploded view of a pivoting mechanism of the fifth embodiment of the present invention.

FIG. 15 illustrates a front sectional view of the fifth embodiment of the present invention.

FIGS. 15A and 15B illustrate sectional views of a sixth embodiment of the present invention and a minor variation of the sixth embodiment.

FIG. 16 illustrates a seventh embodiment of the present invention.

FIG. 16A illustrates a sectional view of the julienne cutting components of the seventh embodiment of the present invention.

FIG. 17A illustrates the components of the adjustable vertical knife assembly of an eighth embodiment of the present invention.

FIGS. 17B and 17C are sectional views of the vertical knife assembly in a raised and lowered position of the eighth embodiment of the present invention.

FIG. 18A illustrates the components of the cutting component of the eighth embodiment of the present invention.

FIGS. 18B and 18C are sectional views of the horizontal knife assembly rotationally attached to the julienne disk of the eighth embodiment of the present invention.

### DETAILED DESCRIPTION

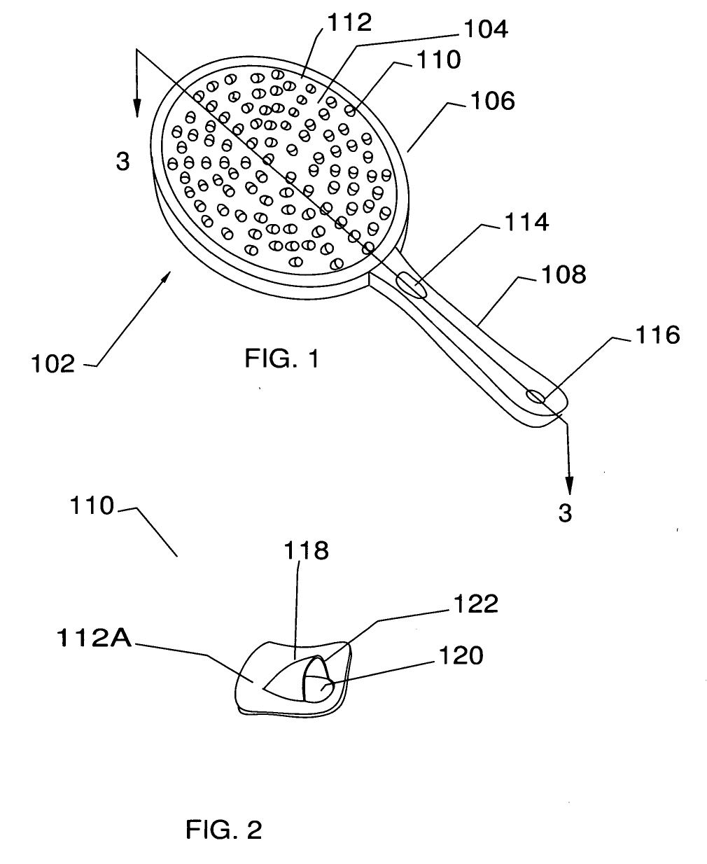

FIG. 1 shows a first embodiment 102 of the present invention. First embodiment 102 is comprised of a circular grating disk 104, an annular collar 106 that supports the grating disk 104 and is positioned around the periphery of circular grating disk 104, and a handle 108 attached to and coplanar with the annular collar 106. Grating disk 104 is comprised of a flat circular surface 112 populated with a multiplicity of grating elements 110 disposed on flat circular surface 112.

FIG. 2 illustrates a perspective view of single grating element 110 disposed on a portion 112A of flat circular surface 112 of grating disk 104 drawn to a larger scale. Grating element 110 is comprised of a protuberance 118 extended above flat circular surface 112A of grating disk 104, an aperture 120 disposed on disk flat circular surface 112A, and a grating cutting edge 122 disposed on protuberance 118. When a food piece is drawn across grating element 110 (right to left in FIG. 2), grating cutting edge 122 engages the food piece such that shredded particles fall through aperture 120.

Referring to FIGS. 1 and 2, each grating element 110 has grating cutting edge 122 approximately in the shape of a planar arc oriented such that a plane containing grating cutting edge 122 is approximately perpendicular to flat circular surface 112 of grating disk 104, and the plane passes through the center of the disk. Each grating cutting edge 122 on grating element 110 is oriented in the same first rotational direction, e.g. counterclockwise, such that when food piece is moved in a second rotational direction, e.g. clockwise, direction relative to grating disk 104 as viewed in FIG. 1, and the food piece is pressed against grating disk 104, the food piece is engaged by the grating cutting edge 122 of grating element 110.

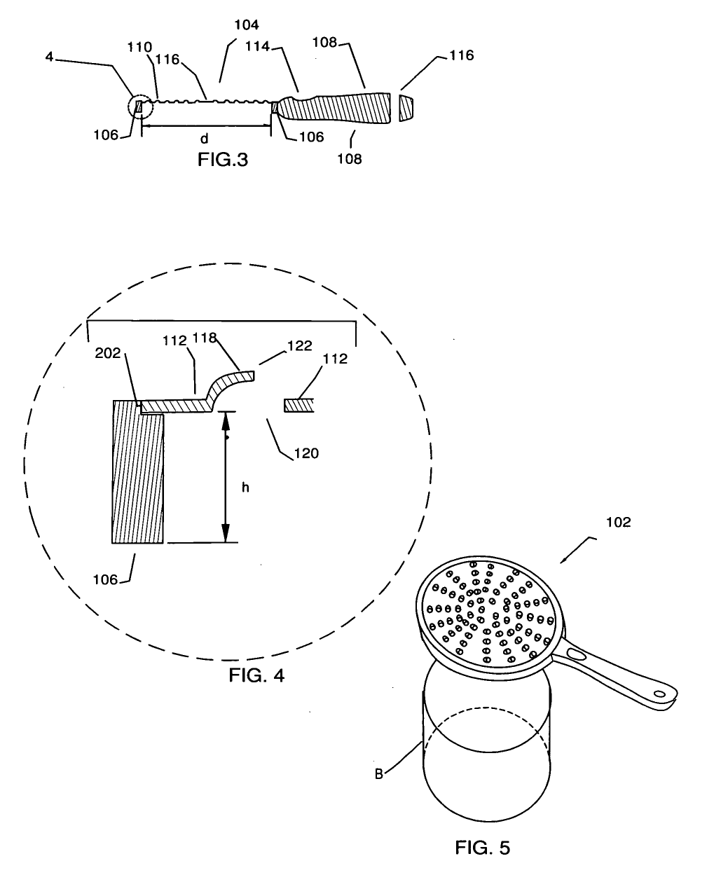

FIG. 3 illustrates a front sectional view of the first embodiment 102 of the present invention 102. FIG. 4 illustrates a detail of FIG. 3. FIG. 4 is drawn to a larger scale than FIG. 3. Annular collar 106 is comprised of a circular solid annular ring that supports grating disk 104. Annular collar 106 has a ledge 202 on its top inner circumference such that grating disk 104 is positioned on ledge 202 as illustrated in FIG. 4. FIG. 4 also illustrates the shape of protuberance 118, the relative disposition of grating cutting edge 122 on protuberance 118, and grating element aperture 120 on a portion of flat circular surface 112A of the grating disk 104. FIGS. 2 and 3 illustrate an optional depression 114 for placing a user's thumb, and an optional handle aperture 116 passing through the handle that may be used for hanging first embodiment 102 on a hook.

Any dimensions and configurations of the various component of the first embodiment consistent with its use are within the scope of this invention. For example, referring to FIGS. 3 through 5, the inner diameter d and the inside bottom height h of the annular collar 106 may be dimensioned so the annular collar 106 fits nicely on top of a home container B of a specific diameter commonly found in a home. The grating disk, described herein as circular, is interpreted in this specification and claims to be substantially circular. It may have a shape that departs slightly for then circular; for example it may be oval or hexagonal with the annular collar configured to accommodate such a shape. Handle 108 may be an integral part of annular collar 106 or may be attached to it with a means such as a bolt. The grating elements may be dimensioned to grate a particular type of food piece.

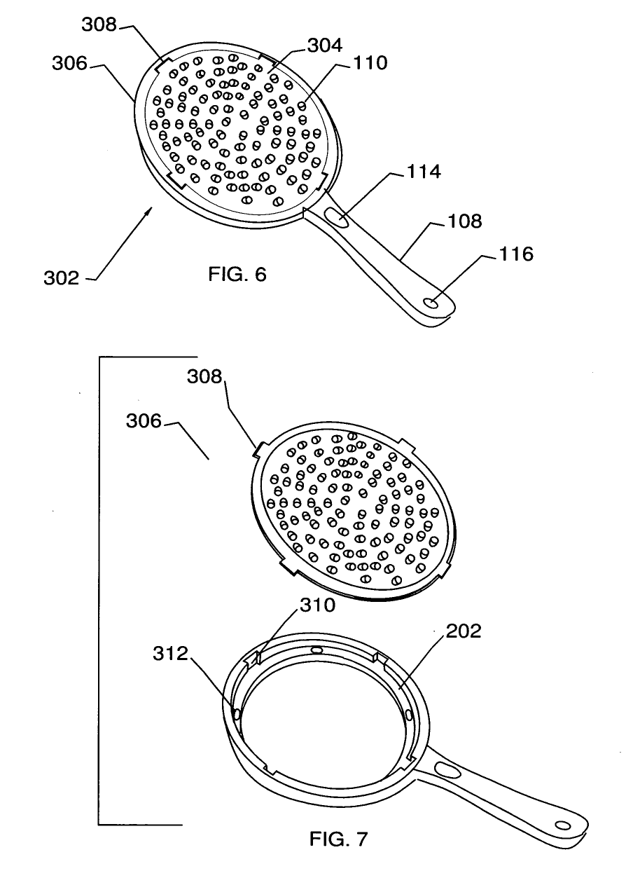

FIG. 6 illustrates a second embodiment 302 of the present invention. Second embodiment 302 is comprised of a grating disk 304, an annular collar 306, and handle 108. It differs from first embodiment 102 of the present invention in that grating disk 304 is removably attached to annular collar 306. FIG. 7 illustrates an exploded view of the second embodiment 302 of the present invention. Grating disk 304 has the same design as first embodiment 102 with one difference. Grating disk 304 has a plurality of tabs 308 joined to grating disk 304 at its periphery; tabs 308 are coplanar with grating disk 304. Annular collar 306 has slots 310 on the inside annular collar above ledge 202. Tabs 308 and slots 310 are dimensioned and configured on grating disk 304 and annular collar 306 such that grating disk 304 fits in annular collar 306 with tabs 308 snugly received by the slots 310 as illustrated in FIG. 6. Magnets 312 are embedded in ledge 202 of the annular collar that hold grating disk 304 in place when second embodiment 302 is in use, but allow the disk to be removed by the user. The removable feature of the second embodiment allows the embodiment to be sold with several interchangeable grating disks 104, wherein each disk has a different dimensioned grating element. To implement second embodiment 302, grating disk 108 of second embodiment 302 must be made out of a material such as a stainless steel that attracts magnets. Alternately, a non-magnetic grating disk may have magnetic material riveted to the tabs.

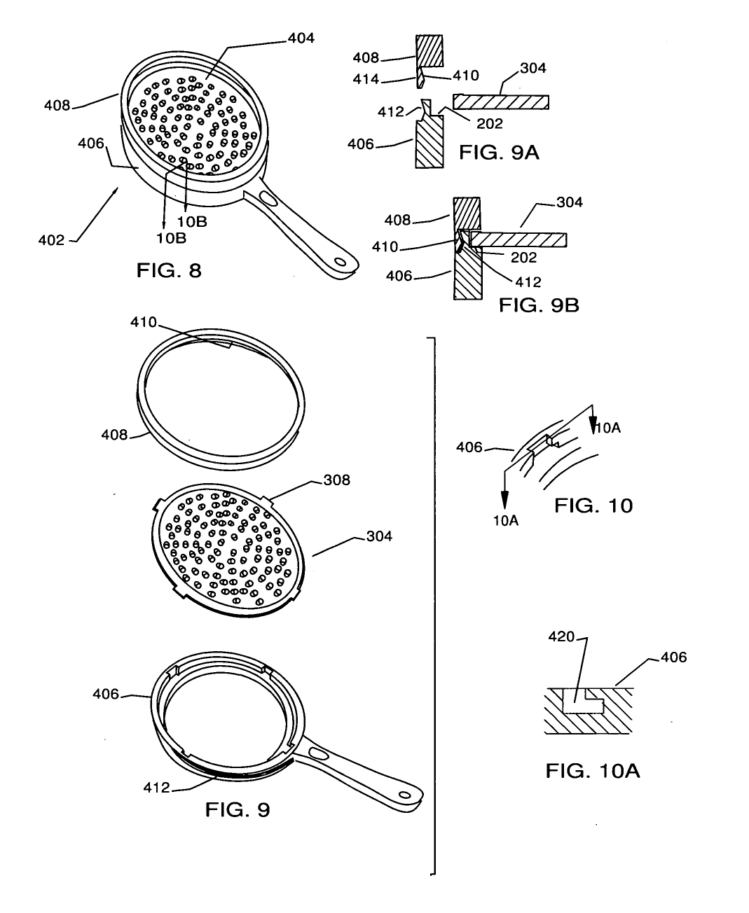

FIG. 8 illustrates a third embodiment 402 of the present invention. It consists of a grating disk with tabs 304, an annular collar 410, and an annular top ring 408. FIG. 9 illustrates an exploded view of the third embodiment of the present invention. Third embodiment 402 is similar to the second embodiment; but with one difference. Instead of using imbedded magnets 312 to secure grating disk 304 to the annular collar 306 as in second embodiment 302, grating disk 304 of third embodiment 402 is secured to annular collar 408 by an annular top ring 408 that fits above annular disk 304 and is removably attached to annular collar 406. Annular top ring 408 has the same outside and inside diameters as annular collar 406. Annular top ring 408 has threads 410 located on a lip 414 that is extended downward from annular top ring 408 such that they engage mating threads 412 on annular collar 406 disposed on the top outside circumference. Other than added threads 412 on the outside bottom of annular collar 410, and the possible reposition of the handle 108 so it doesn't interfere with the threads 412, annular collar 406 is identical to annular collar 306 of second embodiment 302.

FIG. 9A illustrates a sectional view of grating disk 404 ready to be secured to annular collar 406 using annular top ring 408. FIG. 9B illustrates a sectional view of grating disk 404 secured to annular collar 406 using annular top ring 408. Grating disk 404 is secured to annular collar 406 by first placing grating disk 404 on ledge 202 of annular collar 406, then placing annular top ring 408 over annular collar 406, and finally screwing annular top ring 408 onto the annular collar 406 using threads 410 and 412.

FIGS. 10 and 10A illustrate a detailed perspective view and sectional view of an alternate embodiment for attaching tab 308 to annular collar 406. Notched slot 420 is incorporated in annular collar 406. Tab 308 fits into notched slot 420.

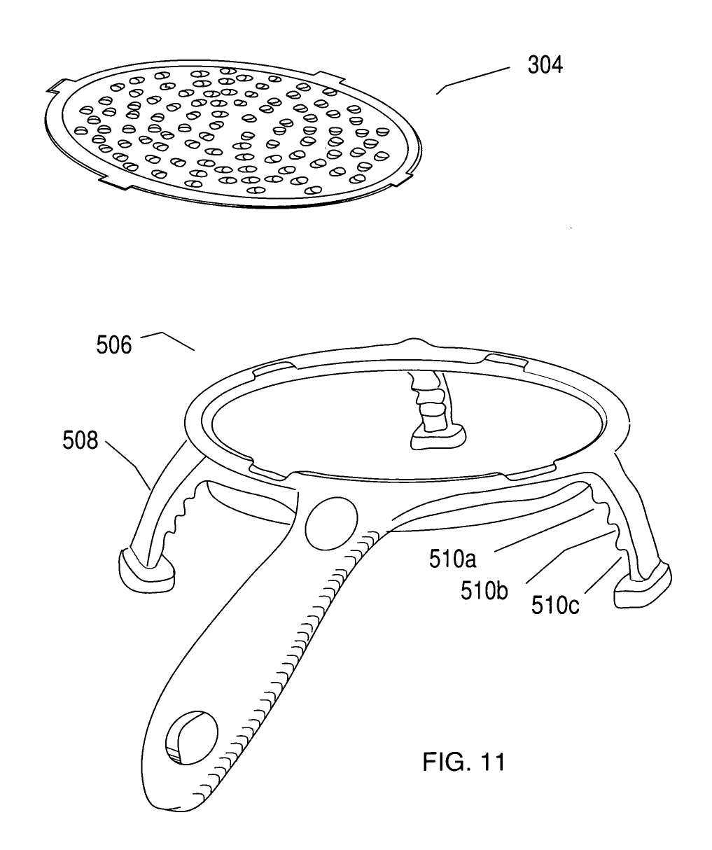

FIG. 11 illustrates an exploded view of a fourth embodiment 502 of the present invention. Fourth embodiment 502 is a modification of second embodiment 302 wherein annular collar 306 of second embodiment 302 is replaced by a base 506 that adds legs 508 to annular collar 306 of the second embodiment 302. As illustrated in FIG. 11, legs 510 have several notches 510a, 510b, 510c disposed on the interior of legs 510. Notches 510a, 510b, 510c are dimensioned and configured such that they allow the fourth embodiment to be placed on the top of containers of four different sizes.

Any dimensions and configurations of the annular collar 306 and the base 506, the handle 108 and the grating disk 304 in the embodiments presented herein, consistent with its intended use as a grater device that is hand-held and has the cutting edges rotationally aligned to the rotational direction of food piece.

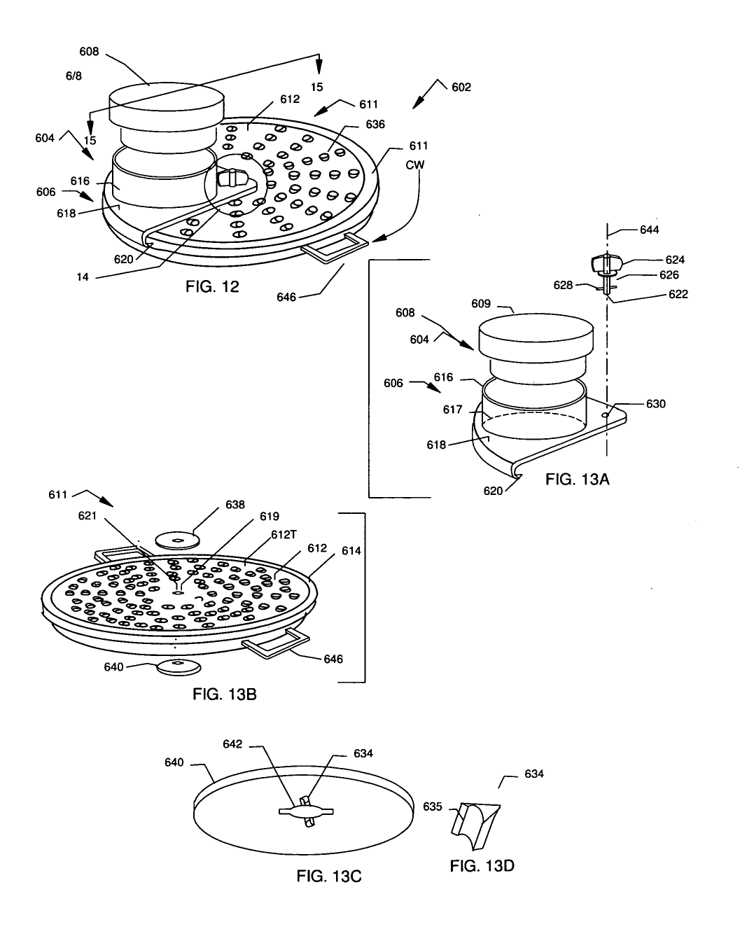

FIG. 12 illustrates an upper front perspective view of a fifth embodiment 602 of the present invention. FIGS. 13A and 13B illustrates an upper front exploded view of the two assemblies, comprising fifth embodiment 602. FIG. 13C illustrates a lower front perspective view of a lower slotted washer 640. FIG. 13D illustrates a cradle stop component of lower slotted washer 640. Referring to FIGS. 12, 13A and 13B, fifth embodiment 602 has food holder assembly 604 rotationally attached to a grating disk assembly 611. Grating disk assembly 611 is comprised of a grating disk 612 having a top surface 612T and a cutting disk center 621 imbedded in an annular collar 614. An upper slotted washer 638 and lower slotted washer 640 are permanently attached to the upper and lower surfaces of grating disk 612. A circular slotted hole 619 is located at center 621 of grating disk 612 and aligned with the slotted holes of upper slotted washer 638 and lower slotted washer 640. Fifth embodiment 602 may have an optional handle 614. Fifth embodiment 602 may be configured to fit on a home container B as show in FIG. 5.

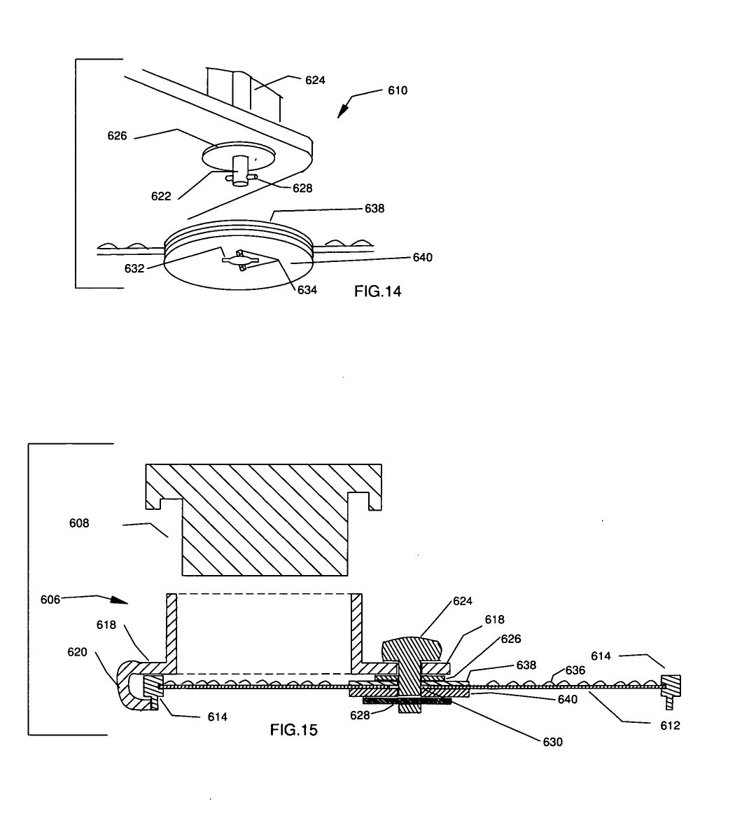

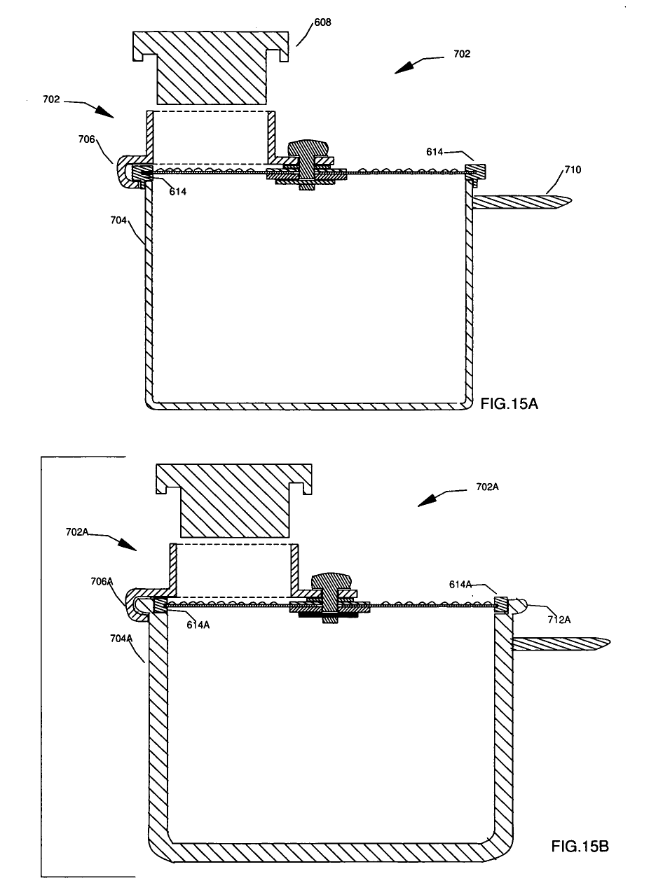

FIG. 14 illustrates, in expanded scale, an exploded view of a pivoting mechanism 610 of fifth embodiment 602. FIG. 15 illustrates a front sectional view of fifth embodiment 602. Referring to FIGS. 12, 13A, 13B, 14 and. 15, fifth embodiment 602 has a food holder assembly 604 rotationally attached to a grating disk assembly 613. Food holder assembly 604 is comprised of a food holder base 606, a plunger 608, and a pivoting mechanism 610. Food holder base 606 is comprised of a food container 616 having a food container opening 617 so that a food piece placed in the food container, 616 may be pressed against the circular grating disk. Food container 616 is attached to a flat shaped circular sector piece 618 that has a curved lip 620 that fits around annular collar 614 and a circular opening 630 at the apex of a circular sector piece 618 that rotationally accommodates a shaft 622 of pivoting mechanism 610. Pivoting mechanism 610 has a turnkey 624 connected to shaft 622. Shaft 622 goes through circular hole 630 located at apex of circular sector piece 618. Shaft 622 is secured to circular sector piece 618 with a pivot collar 626 attached to shaft 622 as illustrated in FIG. 13 such that food holder base 606 rotates freely around shaft 622, but shaft 622 is prevented from being removed from food holder base 606. Shaft 622 has a cylindrical pin 628 that goes through and attached to shaft 622 end perpendicular to longitudinal axis 644 of shaft 622. Grating disk 612 has a circular slotted hole 619 going through its center with slots 632 as illustrated in FIG. 13C. Attached to the grating disk 612 is a pair of cradle stops 634 that restrain cylindrical pin 628 when shaft 622 is rotated in clockwise direction.

FIG. 13D illustrates the cradle stop 634. It has a ridge 635 so the cylindrical pin 628 will snap in the cradle stop 634 when cylindrical pin 628 is pressed against it, but will release cylindrical pin 628 when pressure is applied in the reverse direction

Referring to FIGS. 12, 13A, 13B, 14 and. 15, when a food piece is placed in food holder base opening of a food container 616 of food holder 604, plunger 608 is inserted in opening and pressed against food piece, and the food holder 604 is rotated in a clockwise direction CW, the food piece is cut by the cutting edges 636 of the grating disk 606. Plunger 608 has a gripping element 609 that permits a user to grab and rotate the food holder assembly 604. As the food holder assembly 604 rotates in a clockwise CW direction, the plunger rotates within food container 616.

Fifth embodiment 602 has food container 616 shaped as a circular cylinder. Other shapes are consistent with the inventive concept. If food container 616 has a rectangular shape instead of a circular cylinder shape, then the plunger 608 would have two components, a gripping component, and a plunger base. The plunger base would be designed to fit inside the rectangular container and the gripping element would be designed to rotate relative to the plunger base. A slotted handle pair 646 is included. Although not illustrated in FIGS. 12 and 13B, annular collar 614 may be designed to fit over a home container

Referring again to FIGS. 12, 13A, 13B, 14 and 15, food holder assembly 604 is easily removed from grating disk assembly 611 by turning turnkey 624 clockwise so it is released from cradle stops 634 and so that the circular pin 628 is aligned with the slots in the slotted holes 642 in the slotted washers 638 and 640. Turnkey 624 may then be lifted, releasing shaft 622 from grating disk assembly 611. Curved lip 620 of food holder assembly 604 may then be disengaged from annular collar 614 of grating disk assembly 611. Food holder assembly 604 may be installed on grating disk assembly 611 by reversing these steps.

FIG. 15A illustrates a sectional view of a sixth embodiment 702 of the present invention. Sixth embodiment 702 differs from fifth embodiment 602 in that it has a container 704 as part of embodiment 702. The lip 706 of food holder assembly 708 and container 704 are sized and configured so food assembly 708 rests on container 704. Sixth embodiment 702 has a handle 710 that allows container 704 to be steadied when grating a food piece.

FIG. 15B illustrates a variation 702A of sixth embodiment 702. In this embodiment, container 704A has a ridge 712A that is matched to lip 706A of food holder base 606 that is matched to modified annular collar 614A.

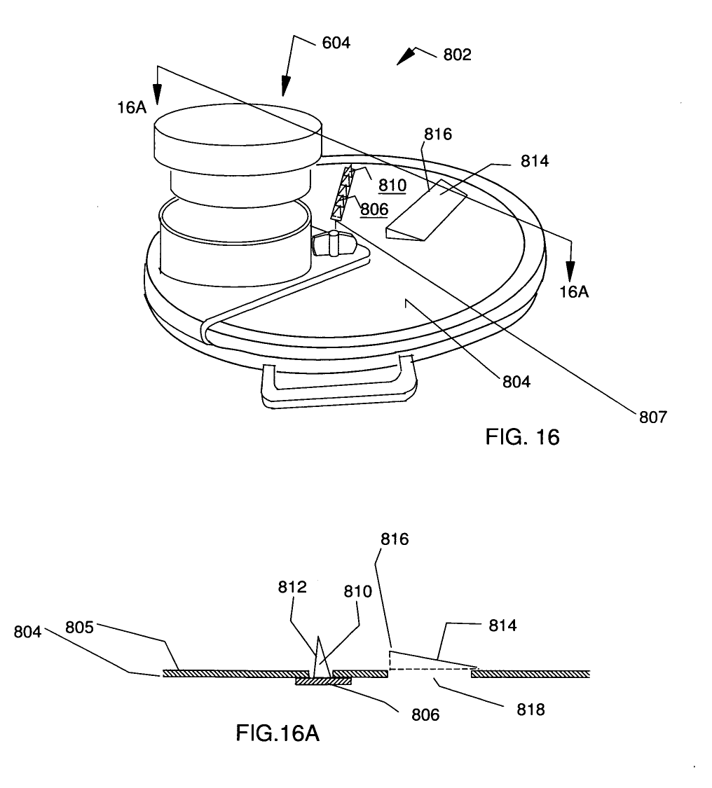

FIG. 16 illustrates a seventh embodiment 802 of the present invention. FIG. 16A is a sectional view of the julienne cutting components of seventh embodiment 802. Seventh embodiment 802 modifies fifth embodiment 602 by replacing grating disk 612 of fifth embodiment 602 by a julienne cutting disk 804. Only the differences between fifth embodiment 602 and seventh embodiment 802 are presented in this disclosure.

Julienne cutting disk 804 cuts a food piece inserted into food holder assembly 604 into thin rectangular strips. Referring to FIGS. 16 and 16A, julienne cutting disk 804 has a vertical knife assembly 806 that has a set of vertical knives 810. The vertical knife cutting edges 812 of vertical knives 810 face left, so when food holder assembly 604 is rotated clockwise, food piece placed in food holder assembly 604 is sliced with the depth of the slices corresponding to the height of the vertical knives 810 above the surface of the julienne cutting disk 804. A horizontal knife cutting component 814 with horizontal knife cutting edge 816 is mounted on surface of cutting disk 804 with horizontal knife cutting edge 816 facing left and parallel to julienne cutting disk 804. When the food piece passes first through vertical knife assembly 806 and then through horizontal knife cutting component 814, the food piece is cut into rectangular strips and falls through the cutting disk opening 818 located below horizontal knife cutting component 814. Seventh embodiment 802 has a loop handle 820 fir convenient handling of into food holder assembly 604.

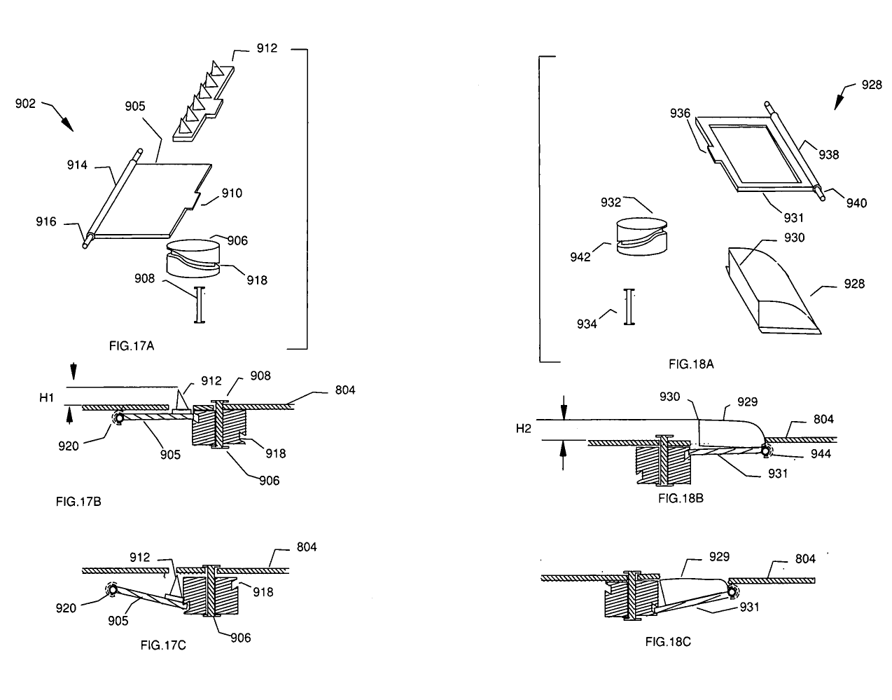

FIGS. 17A and 18A illustrates an eighth embodiment 901 of the present invention. Eighth embodiment 801 enhances seventh embodiment 802 by making the vertical knife height H1 and horizontal cutting edge height H2 adjustable.

FIG. 17A illustrates the components of the adjustable vertical knife assembly 902. Vertical knife assembly 902 is comprised of a rectangular sheet 905, a first drum 906, and a first rivet 908. Rectangular sheet 905 has a rectangular shape with a first tab 910 protruding on the center of the right side, a set of vertical knives 912 mounted on the top right of rectangular sheet 905, and a first tube 914 attached to rectangular sheet 905 on the left side of rectangular sheet 905. A first rod 916 is enclosed in first tube 914 and protrudes on either side of first tube 914. First drum 906 has a continuous closed approximately rectangular first groove 918 cut into its cylindrical surface. First tab 910 fits slidingly into first groove 918.

FIGS. 17B and 17C are sectional views of the vertical knife assembly 902 attached to surface of julienne disk 804. FIG. 17B illustrates the vertical knife assembly 902 when the vertical knives 912 are raised to a height H1 at their maximal extent. First drum 906 is rotationally attached to julienne disk 804 using first rivet 908. FIG. 17C illustrates the vertical knife assembly 902 when the vertical knife blades 912 have a height H1 lowered to their minimal extent. Vertical knife blades 912 are raised and lowered by rotating first drum 906 thereby causing first tab 910 to track the first rod groove 918. First drum 906, groove 918 and rectangular sheet 905 are sized and configured such that rectangular sheet 905 moves smoothly up and down as first drum 906 is rotated. First drum 906 is knurled on its cylindrical surface so it can be turned easily by a user.

FIG. 18A illustrates the components of the horizontal cutting component 928. Horizontal cutting component 928 is comprised of a frame 931, a horizontal cutting component 928 with an upper surface 929 mounted on the top of frame 931, a second drum 932, and a second rivet 932. Frame 931 has a rectangular shape with a second tab 936 protruding on the center of the left side of frame 931, and a second tube 938 attached to frame 931 on the right side of frame 931. A second rod 940 is enclosed in second tube 938 and protrudes on either end of second tube 938. Second drum 932 has a continuous closed approximately rectangular second drum groove 942 cut into its cylindrical surface. Second tab 936 fits into second drum groove 942.

FIGS. 18B and 18C are sectional views of the horizontal knife assembly 928 rotationally attached to disk 804. FIG. 18B illustrates the horizontal knife assembly 928 when the cutting component 928 has a height H2 raised to its maximal extent. Second drum 932 is rotationally attached to julienne disk 804 using second rivet 932. FIG. 18C illustrates the horizontal knife assembly 928 when the cutting component 928 has a height H2 lowered to their minimal extent. Cutting component 928 are raised and lowered by rotating second drum 932 thereby causing second tab 936 to track the second rum groove 942. Second drum 932, second drum groove 942, and frame 931 are sized and configured such that frame 931 moves smoothly up and down as second drum 932 is rotated. Second drum 932 is knurled on its cylindrical surface so it can be turned easily by a user. Upper surface 929 of horizontal knife assembly 928 is shaped so that when of horizontal knife assembly 928 is lowered as illustrated in FIG. 18C, upper surface 929 is positioned approximately at the same level as cutting disk 804,

When horizontal knife cutting edge 816 and vertical knife cutting edges 812 are both raised to the same height, seventh embodiment 802 will cut rectangular slices like French fries. When horizontal knife cutting edge 816 are raised and vertical knife cutting edges 812 is lowered so it doesn't cut a food piece, seventh embodiment 802 will cut slices like tomato slices.

As a modification to eighth embodiment 901, the first drum 906 and second drum 932 may be replaced by a single drum with two grooves that raises and lowers both the vertical knives 810 and horizontal cutting component 928 together as the single drum rotates.

Seventh embodiment 802 illustrates a horizontal slicer and vertical knife assembly installed on a circular disk. In alternate embodiments, more than one pair may be installed on a circular disk; furthermore, the horizontal cutting edge may be curved rather than straight, and the vertical knife assemblies may be curved.

The disclosure presented herein gives multiple embodiments of the present invention. These embodiments are to be considered as only illustrative of the invention and not a limitation of the scope of the present invention. Various permutations, combinations, variations, and extensions of these embodiments are considered to fall within the scope of this invention.

What is claimed is:

1. A device comprising:
a circular food-cutting disk having at least one food cutting element, a cutting disk center, a periphery, a first rotational direction, a second rotational direction and a top surface of the circular food-cutting disk;
the circular food cutting disk having an annular collar attached around its periphery such that the annular collar may be grasped by a user's hand.

2. The device of claim 1 having a plurality of cutting elements wherein each cutting element is a grating element;
each grating element having a grating cutter edge;
each grating cutter edge is oriented in the first rotational direction.

3. The device of claim 1 wherein each cutting element is a horizontal slicing assembly;
the horizontal slicing assembly having a horizontal slicing edge substantially parallel to the top surface, the horizontal slicing edge having a horizontal slicing edge height above the top surface;
the horizontal slicing edge is oriented in the first rotational direction.

4. The device of claim 3 additionally comprising at least one vertical slicing assembly.

5. The food grating device of claim 1 additionally comprising:
a food holding assembly such that the food holding assembly is rotationally attached to the circular grating disk, the rotation occurring around the cutting disk center;
the food holding assembly has a food container for holding a food piece;
the food holding assembly having a plunger that allows a user to push a food piece within the food container against the circular food-cutting disk;
the plunger having a gripping element that allows the food holding assembly to be rotated in the second rotational direction.

6. A food grating device comprising:
a circular grating disk having a cutting disk center, a periphery, a first rotational direction, and a second rotational direction;
the circular grating disk having a plurality of grating elements;
each grating element having a grating cutting edge;
each grating cutting edge is oriented in the first rotational direction;
an annular collar attached around the periphery such that the annular collar may be grasped by a user's hand.

7. The food grating device of claim 6 wherein the annular collar has a handle.

8. The food grating device of claim 6 wherein the annular collar is configured so it may be positioned on a home container.

9. The food grating device of claim 6 additionally comprising:
a food holding assembly such that the food holding assembly is rotationally attached to the circular grating disk, the rotation occurring around the cutting disk center of the circular grating disk;
the food holding assembly has a container for holding food, the food container having an opening so a food piece placed in the food container may be pressed against the circular grating disk;
the food holding assembly has a plunger that allows a user to push a food piece within the food container against the circular grating disk;
the plunger having a gripping element that allows the food holding assembly to be rotated in the second rotational direction.

10. The food grating device of claim 6 having a means for removably attaching the grating disk to the annular collar.

11. The food grating device of claim 9 having a means for removably attaching the food holding assembly to the grating disk.

12. A food slicing device comprising:
a circular slicing disk having a cutting disk center, a periphery, a first rotational direction, a second rotational direction, and a top surface;
the circular disk having at least one horizontal slicing assembly;
each horizontal slicing assembly having a horizontal slicing edge substantially parallel to the top surface, the horizontal slicing edge having a horizontal slicing edge height above the top surface;
the horizontal slicing edge is oriented in the first rotational direction;
an annular collar attached around the periphery such that the annular collar may be grasped by a user's hand.

13. The food slicing device of claim 12 additionally comprising:
a vertical slicing assembly:
vertical slicing assembly having a plurality of vertical cutting knives;
each vertical cutting knife is perpendicular to the top surface;
each vertical cutting knife having a vertical cutting edge, the vertical cutting knife having a vertical cutting knife height above the top surface;
each vertical cutting edge is oriented in the first rotational direction.

14. The food slicing device of claim 12 additionally comprising:
a means for adjusting at least one horizontal knife cutting edge height above the top surface.

15. The food slicing device of claim 13 additionally comprising:
a mechanism for adjusting the vertical cutting knife height of at least one cutting knife above the top surface.

16. The food slicing device of claim 12 additionally comprising:
a food holding assembly such that the food holding assembly is rotationally attached to the circular slicing disk, the rotation occurring around the cutting disk center of the circular slicing disk;
the food holding assembly having a food container for holding food, the food container having an opening so a food piece placed in the food container may be pressed against the circular slicing disk;
the food holding assembly having a plunger that allows a user to push a food piece within the food container against the circular slicing disk;
the plunger having a gripping element that allows the food holding assembly to be rotated in the second rotational direction.

17. The food slicing device of claim 12 having a means for removably attaching the circular slicing disk to the annular collar.

18. The food slicing device of claim 16 having a means for removably attaching the food holding assembly to the circular slicing disk.
